(19) United States
(12) Patent Application Publication
(10) Pub. No.: US 2026/0288635 A1
(43) Pub. Date: Sep. 24, 2026

(54) FILE-BASED GARBAGE COLLECTION

(71) Applicant: Micron Technology, Inc., Boise, ID (US)

(72) Inventors: Chaohui Liu, Shanghai (CN); Liang Ge, Shanghai (CN); Nicola Colella, Capodrise (CE) (IT)

(21) Appl. No.: 19/559,736

(22) Filed: Mar. 6, 2026

Related U.S. Application Data
(60) Provisional application No. 63/773,986, filed on Mar. 18, 2025.

(51) Int. Cl. G06F 12/02

(52) U.S. Cl. CPC G06F 12/0253; G06F 2212/7205

(57) ABSTRACT

Methods, systems, and devices for file-based garbage collection are described. A host system may divide a logical address space corresponding to one or more files into multiple zones, each zone of the multiple zones being allocated a respective set of logical block addresses (LBAs). Additionally, the host system may replace a first LBA allocated to a first zone of the multiple zones with a second LBA in response to the first LBA being invalid and store, in response to replacing the first LBA with the second LBA, a mapping between the second LBA and an identifier of a file of the one or more files corresponding to the first zone to memory of the host system. Further, the host system may update, as part of file-based garbage collection, the second LBA to be a third LBA in response to reading the identifier of the file from the memory.

### CROSS REFERENCE

The present Application for Patent claims priority to U.S. Patent Application No. 63/773,986 by Liu et al., entitled “FILE-BASED GARBAGE COLLECTION,” filed March 18, 2025, which is assigned to the assignee hereof, and which is expressly incorporated by reference in its entirety herein.

### TECHNICAL FIELD

The following relates to one or more systems for memory, including file-based garbage collection.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports file-based garbage collection in accordance with examples as disclosed herein.

FIG. 2 shows an example of a scheme that supports file-based garbage collection in accordance with examples as disclosed herein.

FIG. 3 shows an example of a flow diagram that supports file-based garbage collection in accordance with examples as disclosed herein.

FIG. 4 shows an example of a flow diagram that supports file-based garbage collection in accordance with examples as disclosed herein.

FIG. 5 shows an example block diagram of a host system that supports file-based garbage collection in accordance with examples as disclosed herein.

FIG. 6 shows an example flowchart illustrating a method or methods that support file-based garbage collection in accordance with examples as disclosed herein.

### DETAILED DESCRIPTION

A host system may implement a file system that supports zone universal flash storage (zUFS). To support zUFS, the file system may divide a logical address space corresponding to one or more files into multiple zones that each include a consecutive range of logical block addresses (LBAs) of the logical address space. During operation, the file system may update a file resulting in LBAs of the file being replaced with other LBAs leading to discrete (or non-consecutive) LBAs in the file and zones of the file. During garbage collection (e.g., non-file-based garbage collection), the host system may copy valid LBAs of a segment to consecutive source LBAs, but the host system may not consider the files corresponding to the valid LBAs and thus, even after non-file-based garbage collection, the files or the zones of the files may include discrete LBAs, which can lead to inefficiency in reading the files and other challenges.

An enhanced file-based garbage operation that supports zone UFS is described. In some examples, the file system of the host system may store a mapping from LBA to parent node (or parent file). Further, as files are updated, the file system of the host system may store an indication of a set of LBAs that correspond to one or more (or each) parent node. During file-based garbage collection, the host system may identify a valid LBA of a logical address space (e.g., a segment) and identify a set of LBAs corresponding to the parent node of the valid LBA using the stored information (e.g., the mapping). Upon determining the set of LBAs, the host system may set the set of LBAs as source LBAs and copy the source LBAs to consecutive destination LBAs of the logical address space. Thus, using these methods, LBAs of the same file (or parent node) may be grouped in consecutive LBAs.

In addition to applicability in memory systems as described herein, techniques for file-based garbage collection may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, among other benefits.

Features of the disclosure are illustrated and described in the context of systems, devices, and circuits. Features of the disclosure are further illustrated and described in the context of flow diagrams and flowcharts.

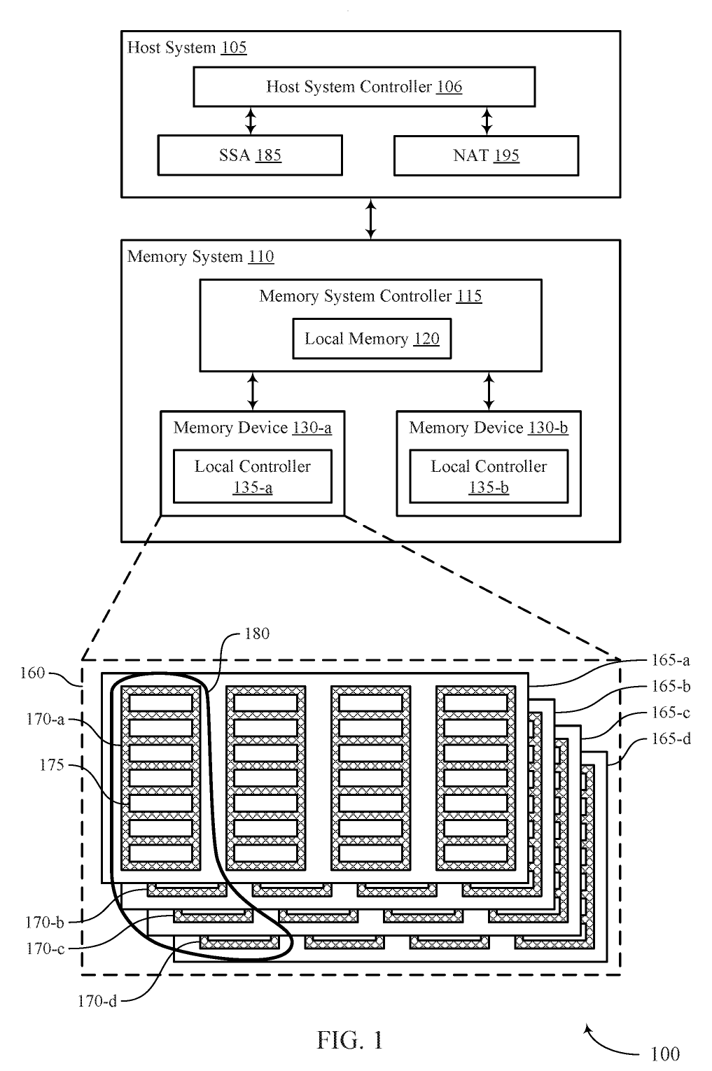

FIG. 1 shows an example of a system 100 that supports file-based garbage collection in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some examples, the host system 105 may support a F2FS. The F2FS may divide the whole volume (e.g., memory corresponding to the F2FS) into multiple areas. The multiple areas may include a superblock, a checkpoint, a segment information table (SIT), a node address table (NAT) 195, a segment summary area (SSA) 185, and a main area. The NAT 195 may be described as an address table for the main area node blocks. The SSA 185 may include entries which contain the owner information of the main area data and node blocks.

In some examples, the system 100 may support file-based garbage collection. To support file-based garbage collection, the host system 105 may divide a logical address space corresponding to one or more files into a multiple zones, each zone of the multiple zones being allocated a respective set of LBAs. Additionally, the host system 105 may replace a first LBA allocated to a first zone of the multiple zones with a second LBA in response to the first LBA being invalid and store, in response to replacing the first LBA with the second LBA, a mapping between the second LBA and an identifier of a file of the one or more files corresponding to the first zone to memory of the host system 105. Further, the host system 105 may update, as part of file-based garbage collection, the second LBA to be a third LBA in response to reading the identifier of the file from the memory.

The system 100 may include any quantity of non-transitory computer readable media that support file-based garbage collection. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

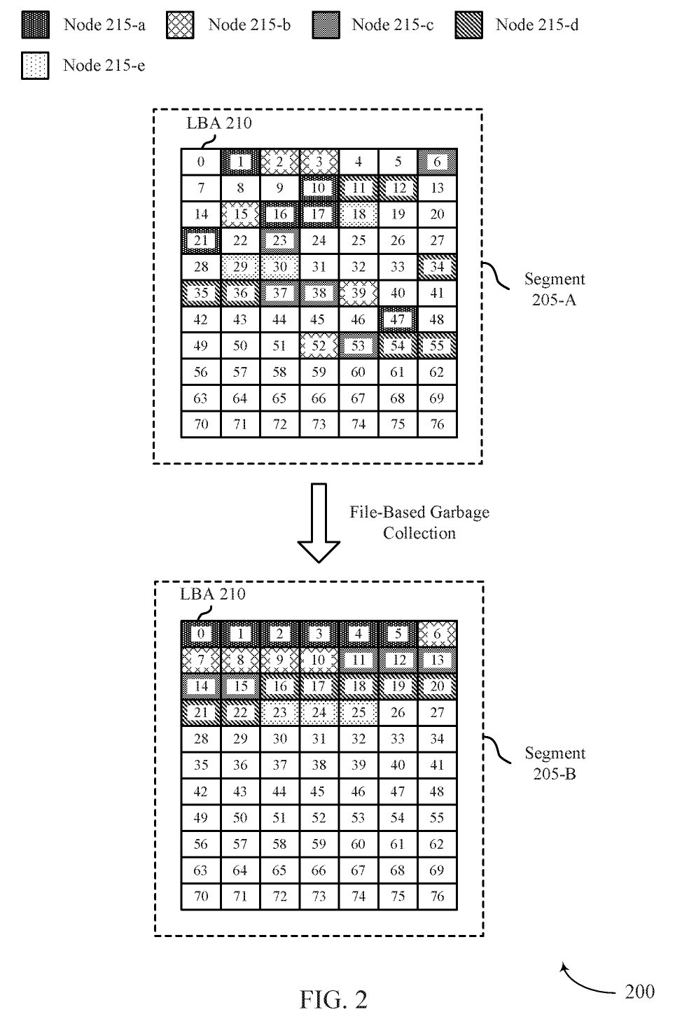

FIG. 2 shows an example of a scheme 200 that supports file-based garbage collection in accordance with examples as disclosed herein. In some examples, the scheme 200 may be implemented by aspects of the system 100. For example, the scheme 200 may be implemented by the host system 105 as described with reference to FIG. 1.

In some examples, a host system may implement a file system or more specifically, a flash-friendly file system (F2FS). The F2FS may be described as a flash file system that considers characteristics of a type of memory system (e.g., a NAND memory system) and is designed on the basis of a log-structured file system. In some examples, the F2FS may support zUFS. To support zUFS, the F2FS may divide a logical address space corresponding to one or more files into multiple zones and each zone of the multiple zones may be allocated a respective set of LBAs of the logical address space. zUFS may support sequential writes constrained to a zone which may enable higher bandwidth, lower latency, and reduced write amplification by eliminating L2P table size, reducing memory system garbage collection, etc.

However, in some examples, LBAs of a file may become more discrete over time resulting in defragmented zones and a loss of performance (e.g., host system IO overhead, host system file management cost, reduction in memory system read performance, reduction in memory system bandwidth, higher latency at the memory system). During operation, the F2FS may update files of the F2FS. Updating the files may include allocating new LBAs to the files and invalidating the old LBAs of the files. Later, during garbage collection (e.g., non-file-based garbage collection), the host system may copy the valid source LBAs of a segment (e.g., a logical address space that spans multiple files) to consecutive destination LBAs of the segment. However, the host system may not consider the parent file (or parent node) corresponding to the valid source LBAs during garbage collection. As a result, the LBAs corresponding to a particular file or zone may be non-consecutive.

As described herein, the host system may adopt file-based garbage collection which may allow the host system to arrange a file in sequential LBAs to reduce file or zone fragmentation. In some examples, the host system may perform file-based garbage collection on a segment 205. As shown in FIG. 2, the segment 205 may include LBAs 210 mapped to one of a first file (or a node 215-a), a second file (or a node 215-b), a third file (or a node 215-c), a fourth file (or a node 215-d), or a fifth file (or a node 215-e). In the example of FIG. 2, consecutive LBAs 210 of the segment 205 may run from left to right, top to bottom (e.g., from LBA 0 to LBA 76). Further, FIG. 2 may illustrate the segment 205 during different periods of operation. A segment 205-a may illustrate the segment 205 prior to file-based garbage collection, while a segment 205-b may illustrate the segment 205 after file-based garbage collection.

Prior to file-based garbage collection, the F2FS may divide a logical address space into multiple zones that each correspond to a respective file of the multiple files and includes a set of consecutive LBAs 210. Over time, the F2FS may update the files. For example, the F2FS may replace a first LBA 210 allocated to a first zone that corresponds to the second file or the node 215-b with a second LBA in response to the first LBA being invalid. As the F2FS updates the files, the F2FS may store information related to the files. For example, the F2FS may utilize an SSA region to store parent node information related to each of the LBAs 210 or a mapping from LBA 210 to file. As an example, after updating the second file, the F2FS may store a mapping between the second LBA and an identifier associated with the node 215-b. Further, the F2FS may store an offset value along with the mapping that indicates a position of the respective LBA 210 within the file. That is, how far down the respective LBA 210 is in a list of LBAs 210 corresponding to the file. In some examples, the offset value may indicate a zone of the respective LBA 210.

Additionally, as files are updated, the F2FS may keep a record of all of the LBAs 210 corresponding to each of the files of the multiple files. In some examples, the host system may identify the LBAs 210 corresponding to a file using a NAT region. The F2FS may utilize the NAT region to store a mapping from a node to a memory location (or block address) used to store the LBAs 210 corresponding to the node. Thus, the host system may identify all of the LBAs 210 corresponding to a file by reading the memory location mapped to the file as indicated in the NAT region.

As a result of updating the files, the segment 205 may include the segment 205-a. In segment 205-a, the LBAs 210 corresponding to a respective node 215 may be mapped to at least two non-consecutive LBAs 210. For example, as shown in segment 205-a, LBAs 210 corresponding to the node 215-b may be mapped to an LBA 2, an LBA 3, an LBA 15, an LBA 39, and an LBA 52. To rearrange the LBAs 210, the host system may perform file-based garbage collection on the segment 205-a resulting in the segment 205-b. As a part of file-based garbage collection, the host system may identify a valid LBA 210 of the segment 205-a. As an example, the host system may identify LBA 1.

Upon identifying the valid LBA 210, the host system may identify the parent node of the valid LBA 210 using the SSA region. For example, the host system may identify that the parent node of the LBA 1 includes the node 215-a in response to reading the SSA region. The host system may then identify the LBAs 210 corresponding to the node 215-b using the NAT region. For example, the host system may identify that LBAs 210 of the node 215-a may include LBA 1, LBA 10, LBA 16, LBA 17, LBA 21, and LBA 47. The host system may then update the LBAs 210 of the node 215-b or a subset of the LBAs 210 corresponding to a selected zone to be consecutive LBAs 210. For example, as shown in segment 205-b, the LBAs 210 of the node 215-a may include LBA 0, LBA 1, LBA 2, LBA 3, LBA 4, and LBA 5. Thus, using these methods, the host system may reduce file and zone fragmentation. In some examples, the host system may repeat the above-mentioned file-based garbage collection for the remaining files of the segment. Further, in some examples, the host system may send a copy command indicating to copy the source LBAs 210 (e.g., LBAs obtained from NAT region) to the destination LBAs 210 (e.g., the consecutive LBAs).

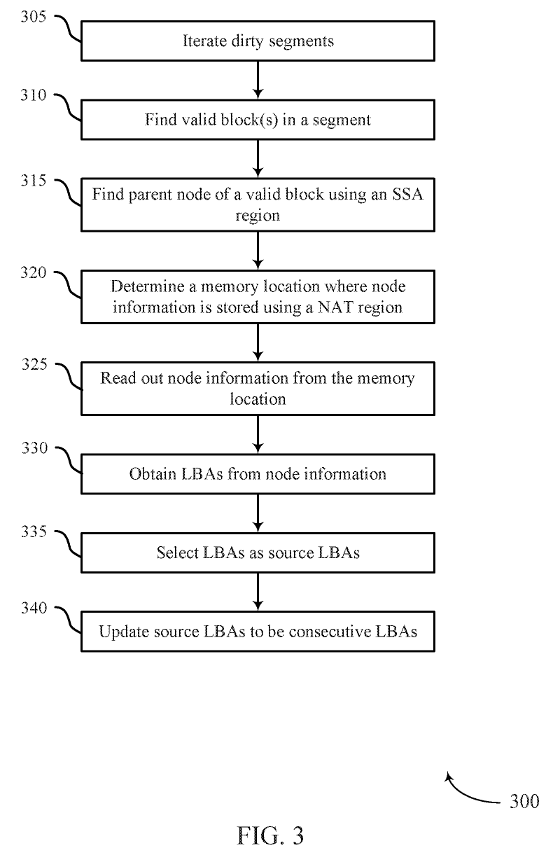

FIG. 3 shows an example of a flow diagram 300 that supports file-based garbage collection in accordance with examples as disclosed herein. In some examples, the flow diagram 300 may be implemented by aspects of the system 100. For example, the flow diagram 300 may be implemented by the host system 105 as described with reference to FIG. 1.

At 305, the host system may identify (or iterate) dirty segments in a selected region of a logical address space. In some examples, dirty segments may refer to areas of the logical address space that may be “cleaned” by garbage collection.

At 310, the host system may select a segment in response to identifying the dirty segments and find valid logical block(s) within the segment.

At 315, the host system may find a parent node (e.g., an identifier corresponding to a file) of a valid logical block of the identified valid logical blocks using an SSA region.

At 320, the host system may find a memory location that stores node information corresponding to the parent node using a NAT region.

At 325, the host system may read out node information from the memory location.

At 330, the host system may obtain a set of LBAs from the node information. The set of LBAs may include LBAs that correspond to a same file.

At 335, the host system may select source LBA as the set of LBAs obtained from the node information.

At 340, the host system may update the source LBAs to be consecutive destination LBAs and transmit a copy command, to a memory system, indicating to copy the source LBAs to the consecutive destination LBAs. In some examples, the host system may perform steps 310 through 340 for each segment and steps 315 through 340 for each file corresponding to the segment. In some examples, the host system may perform one or more of the steps 305 through 340 during sleep.

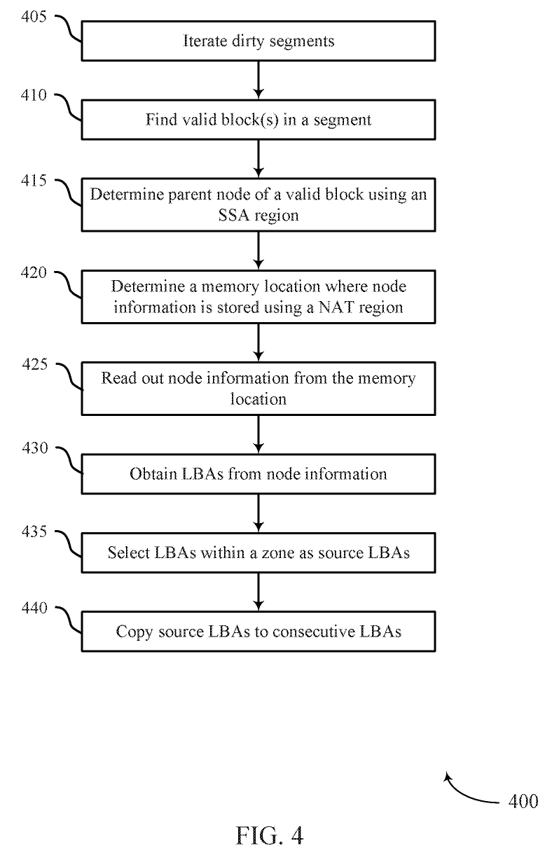

FIG. 4 shows an example of a flow diagram 400 that supports file-based garbage collection in accordance with examples as disclosed herein. In some examples, the flow diagram 400 may be implemented by aspects of the system 100. For example, the flow diagram 400 may be implemented by the host system 105 as described with reference to FIG. 1.

At 405, the host system may identify (or iterate) dirty segments in a selected region.

At 410, the host system may select a segment in response to identifying the dirty segments and find valid logical block(s) within the segment. In some examples, dirty segments may refer to areas of the logical address space that may be “cleaned” by garbage collection.

At 415, the host system may find a parent node (e.g., an identifier corresponding to a file) of a valid logical block of the identified valid logical blocks using an SSA region.

At 420, the host system may find a memory location that stores node information corresponding to the parent node using a NAT region.

At 425, the host system may read out node information from the memory location.

At 430, the host system may obtain a set of LBAs from the node information. The set of LBAs may include LBAs that correspond to a same file.

At 435, the host system may select a subset of LBAs within a zone from the set of LBAs obtained from the node information and set the selected subset of LBAs as source LBAs. The subset of LBAs may include LBAs that correspond to a same file and a same zone.

At 440, the host system may update the source LBAs to be consecutive destination LBAs and transmit a copy command, to a memory system, indicating to copy the source LBAs to the consecutive destination LBAs. In some examples, the host system may perform steps 410 through 440 for each segment, steps 415 through 440 for each file corresponding to the segment, and steps 435 and 430 for each zone of the file. Using the flow diagram 400 as opposed to the flow diagram 300 may result in more copy commands being sent from the host system to the memory system because the flow diagram 300 refers to file-based garbage collection, whereas the flow diagram 400 refers to file-based garbage collection within a zone. In some examples, the host system may perform one or more of the steps 405 through 440 during sleep.

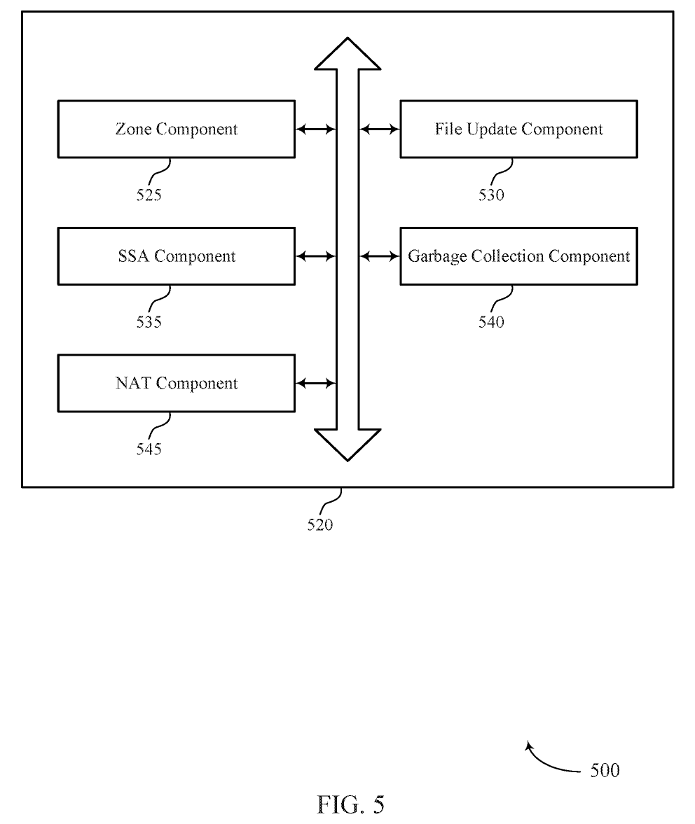

FIG. 5 shows a block diagram 500 of a host system 520 that supports file-based garbage collection in accordance with examples as disclosed herein. The host system 520 may be an example of aspects of a host system as described with reference to FIGS. 1 through 4. The host system 520, or various components thereof, may be an example of means for performing various aspects of file-based garbage collection as described herein. For example, the host system 520 may include a zone component 525, a file update component 530, an SSA component 535, a garbage collection component 540, a NAT component 545, or any combination thereof. Each of these components, or components of subcomponents thereof (e.g., one or more processors, one or more memories), may communicate, directly or indirectly, with one another (e.g., via one or more buses).

The zone component 525 may be configured as or otherwise support a means for dividing a logical address space corresponding to one or more files into a plurality of zones, each zone of the plurality of zones being allocated a respective set of LBAs. The file update component 530 may be configured as or otherwise support a means for replacing a first LBA allocated to a first zone of the plurality of zones with a second LBA in response to the first LBA being invalid. The SSA component 535 may be configured as or otherwise support a means for storing, in response to replacing the first LBA with the second LBA, a mapping between the second LBA and an identifier of a file of the one or more files corresponding to the first zone to memory of the host system. The garbage collection component 540 may be configured as or otherwise support a means for updating, as part of a garbage collection operation, the second LBA to be a third LBA in response to reading the identifier of the file from the memory.

In some examples, the garbage collection component 540 may be configured as or otherwise support a means for identifying, as part of the garbage collection operation, that the second LBA is valid, where reading the identifier of the file from the memory is in response to identifying that the second LBA is valid.

In some examples, the NAT component 545 may be configured as or otherwise support a means for storing a mapping between the identifier of the file and a plurality of LBAs in second memory of the host system.

In some examples, the garbage collection component 540 may be configured as or otherwise support a means for reading, as part of the garbage collection operation, the plurality of LBAs in response to reading the identifier of the file from the memory.

In some examples, to support updating the second LBA, the garbage collection component 540 may be configured as or otherwise support a means for updating the plurality of LBAs that include non-consecutive LBAs to be a second plurality of LBAs that include consecutive LBAs.

In some examples, to support updating the second LBA, the garbage collection component 540 may be configured as or otherwise support a means for updating the respective set of LBAs within the plurality of LBAs that correspond to the first zone to be a second set of LBAs that include consecutive LBAs.

In some examples, the respective set of LBAs allocated to the first zone include non-consecutive LBAs after replacing the first LBA with the second LBA; and the respective set of LBAs allocated to the first zone include consecutive LBAs after updating the second LBA to be the third LBA. In some examples, the memory includes an SSA region. In some examples, the host system supports a F2FS.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

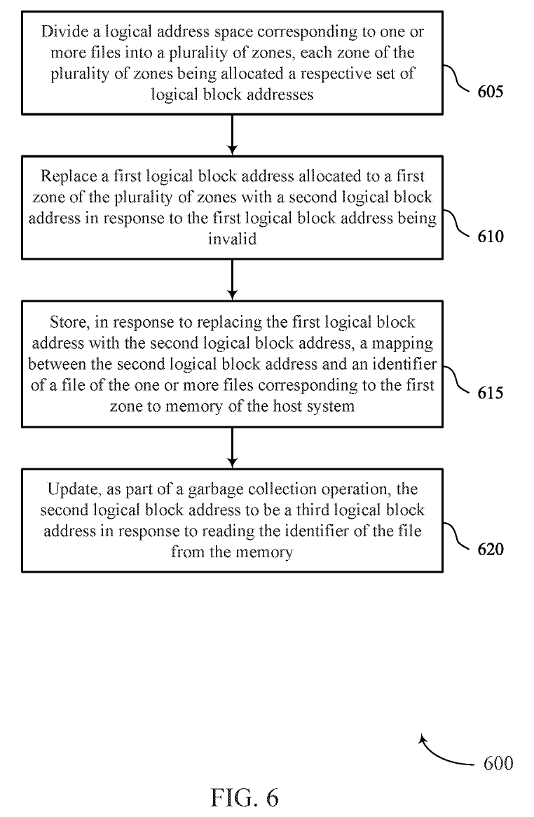

FIG. 6 shows a flowchart illustrating a method 600 that supports file-based garbage collection in accordance with examples as disclosed herein. The operations of method 600 may be implemented by a host system or its components as described herein. For example, the operations of method 600 may be performed by a host system as described with reference to FIGS. 1 through 5. In some examples, a host system may execute a set of instructions to control the functional elements of the device to perform the described functions. Additionally, or alternatively, the host system may perform aspects of the described functions using special-purpose hardware.

At 605, the method may include dividing a logical address space corresponding to one or more files into a plurality of zones, each zone of the plurality of zones being allocated a respective set of LBAs. In some examples, aspects of the operations of 605 may be performed by a zone component 525 as described with reference to FIG. 5.

At 610, the method may include replacing a first LBA allocated to a first zone of the plurality of zones with a second LBA in response to the first LBA being invalid. In some examples, aspects of the operations of 610 may be performed by a file update component 530 as described with reference to FIG. 5.

At 615, the method may include storing, in response to replacing the first LBA with the second LBA, a mapping between the second LBA and an identifier of a file of the one or more files corresponding to the first zone to memory of the host system. In some examples, aspects of the operations of 615 may be performed by an SSA component 535 as described with reference to FIG. 5.

At 620, the method may include updating, as part of a garbage collection operation, the second LBA to be a third LBA in response to reading the identifier of the file from the memory. In some examples, aspects of the operations of 620 may be performed by a garbage collection component 540 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for dividing a logical address space corresponding to one or more files into a plurality of zones, each zone of the plurality of zones being allocated a respective set of LBAs; replacing a first LBA allocated to a first zone of the plurality of zones with a second LBA in response to the first LBA being invalid; storing, in response to replacing the first LBA with the second LBA, a mapping between the second LBA and an identifier of a file of the one or more files corresponding to the first zone to memory of the host system; and updating, as part of a garbage collection operation, the second LBA to be a third LBA in response to reading the identifier of the file from the memory.

Aspect 2: The method, apparatus, or non-transitory computer-readable medium of aspect 1, further including operations, features, circuitry, logic, means, or instructions, or any combination thereof for identifying, as part of the garbage collection operation, that the second LBA is valid, where reading the identifier of the file from the memory is in response to identifying that the second LBA is valid.

Aspect 3: The method, apparatus, or non-transitory computer-readable medium of any of aspects 1 through 2, further including operations, features, circuitry, logic, means, or instructions, or any combination thereof for storing a mapping between the identifier of the file and a plurality of LBAs in second memory of the host system.

Aspect 4: The method, apparatus, or non-transitory computer-readable medium of aspect 3, further including operations, features, circuitry, logic, means, or instructions, or any combination thereof for reading, as part of the garbage collection operation, the plurality of LBAs in response to reading the identifier of the file from the memory.

Aspect 5: The method, apparatus, or non-transitory computer-readable medium of aspect 4, where updating the second LBA includes operations, features, circuitry, logic, means, or instructions, or any combination thereof for updating the plurality of LBAs that include non-consecutive LBAs to be a second plurality of LBAs that include consecutive LBAs.

Aspect 6: The method, apparatus, or non-transitory computer-readable medium of any of aspects 4 through 5, where updating the second LBA includes operations, features, circuitry, logic, means, or instructions, or any combination thereof for updating the respective set of LBAs within the plurality of LBAs that correspond to the first zone to be a second set of LBAs that include consecutive LBAs.

Aspect 7: The method, apparatus, or non-transitory computer-readable medium of any of aspects 1 through 6, where the respective set of LBAs allocated to the first zone include non-consecutive LBAs after replacing the first LBA with the second LBA; and the respective set of LBAs allocated to the first zone include consecutive LBAs after updating the second LBA to be the third LBA.

Aspect 8: The method, apparatus, or non-transitory computer-readable medium of any of aspects 1 through 7, where the memory includes an SSA region.

Aspect 9: The method, apparatus, or non-transitory computer-readable medium of any of aspects 1 through 8, where the host system supports a F2FS.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A host system, comprising:
one or more interfaces comprising one or more signal paths operable for communications with one or more memory systems; and
processing circuitry coupled with the one or more interfaces and configured to cause the host system to:
divide a logical address space corresponding to one or more files into a plurality of zones, each zone of the plurality of zones being allocated a respective set of logical block addresses;
replace a first logical block address allocated to a first zone of the plurality of zones with a second logical block address in response to the first logical block address being invalid;
store, in response to replacing the first logical block address with the second logical block address, a mapping between the second logical block address and an identifier of a file of the one or more files corresponding to the first zone to memory of the host system; and
update, as part of a garbage collection operation, the second logical block address to be a third logical block address in response to reading the identifier of the file from the memory.

2. The host system of claim 1, wherein the processing circuitry is further configured to cause the host system to:
identify, as part of the garbage collection operation, that the second logical block address is valid, wherein reading the identifier of the file from the memory is in response to identifying that the second logical block address is valid.

3. The host system of claim 1, wherein the processing circuitry is further configured to cause the host system to:
store a mapping between the identifier of the file and a plurality of logical block addresses in second memory of the host system.

4. The host system of claim 3, wherein the processing circuitry is further configured to cause the host system to:
read, as part of the garbage collection operation, the plurality of logical block addresses in response to reading the identifier of the file from the memory.

5. The host system of claim 4, wherein updating the second logical block address comprises the processing circuitry configured to cause the host system to:
update the plurality of logical block addresses that comprise non-consecutive logical block addresses to be a second plurality of logical block addresses that comprise consecutive logical block addresses.

6. The host system of claim 4, wherein updating the second logical block address comprises the processing circuitry configured to cause the host system to:
update the respective set of logical block addresses within the plurality of logical block addresses that correspond to the first zone to be a second set of logical block addresses that comprise consecutive logical block addresses.

7. The host system of claim 1, wherein:
the respective set of logical block addresses allocated to the first zone comprise non-consecutive logical block addresses after replacing the first logical block address with the second logical block address; and
the respective set of logical block addresses allocated to the first zone comprise consecutive logical block addresses after updating the second logical block address to be the third logical block address.

8. The host system of claim 1, wherein the memory comprises a segment summary area (SSA) region.

9. The host system of claim 1, wherein the host system supports a flash-friendly file system.

10. A non-transitory computer-readable medium storing code comprising instructions which, when executed by processing circuitry of a host system, cause the host system to:
divide a logical address space corresponding to one or more files into a plurality of zones, each zone of the plurality of zones being allocated a respective set of logical block addresses;
replace a first logical block address allocated to a first zone of the plurality of zones with a second logical block address in response to the first logical block address being invalid;
store, in response to replacing the first logical block address with the second logical block address, a mapping between the second logical block address and an identifier of a file of the one or more files corresponding to the first zone to memory of the host system; and
update, as part of a garbage collection operation, the second logical block address to be a third logical block address in response to reading the identifier of the file from the memory.

11. The non-transitory computer-readable medium of claim 10, wherein the instructions, when executed by the processing circuitry of the host system, further cause the host system to:
identify, as part of the garbage collection operation, that the second logical block address is valid, wherein reading the identifier of the file from the memory is in response to identifying that the second logical block address is valid.

12. The non-transitory computer-readable medium of claim 10, wherein the instructions, when executed by the processing circuitry of the host system, further cause the host system to:
store a mapping between the identifier of the file and a plurality of logical block addresses in second memory of the host system.

13. The non-transitory computer-readable medium of claim 12, wherein the instructions, when executed by the processing circuitry of the host system, further cause the host system to:
read, as part of the garbage collection operation, the plurality of logical block addresses in response to reading the identifier of the file from the memory.

14. The non-transitory computer-readable medium of claim 13, wherein the instructions to update the second logical block address, when executed by the processing circuitry of the host system, cause the host system to:
update the plurality of logical block addresses that comprise non-consecutive logical block addresses to be a second plurality of logical block addresses that comprise consecutive logical block addresses.

15. The non-transitory computer-readable medium of claim 13, wherein the instructions to update the second logical block address, when executed by the processing circuitry of the host system, cause the host system to:
update the respective set of logical block addresses within the plurality of logical block addresses that correspond to the first zone to be a second set of logical block addresses that comprise consecutive logical block addresses.

16. The non-transitory computer-readable medium of claim 10, wherein:
the respective set of logical block addresses allocated to the first zone comprise non-consecutive logical block addresses after replacing the first logical block address with the second logical block address; and
the respective set of logical block addresses allocated to the first zone comprise consecutive logical block addresses after updating the second logical block address to be the third logical block address.

17. The non-transitory computer-readable medium of claim 10, wherein the memory comprises a segment summary area (SSA) region.

18. The non-transitory computer-readable medium of claim 10, wherein the host system supports a flash-friendly file system.

19. A method by a host system, comprising:
dividing a logical address space corresponding to one or more files into a plurality of zones, each zone of the plurality of zones being allocated a respective set of logical block addresses;
replacing a first logical block address allocated to a first zone of the plurality of zones with a second logical block address in response to the first logical block address being invalid;
storing, in response to replacing the first logical block address with the second logical block address, a mapping between the second logical block address and an identifier of a file of the one or more files corresponding to the first zone to memory of the host system; and
updating, as part of a garbage collection operation, the second logical block address to be a third logical block address in response to reading the identifier of the file from the memory.

20. The method of claim 19, further comprising:
identifying, as part of the garbage collection operation, that the second logical block address is valid, wherein reading the identifier of the file from the memory is in response to identifying that the second logical block address is valid.

21. The method of claim 19, further comprising:
storing a mapping between the identifier of the file and a plurality of logical block addresses in second memory of the host system.

22. The method of claim 21, further comprising:
reading, as part of the garbage collection operation, the plurality of logical block addresses in response to reading the identifier of the file from the memory.
